(19) United States
(12) Patent Application Publication
(10) Pub. No.: US 2004/0131157 A1
(43) Pub. Date: Jul. 8, 2004

(54) LED based light source with uniform light field & well defined edges

(75) Inventors: Ljubisa Dragoljub Stevanovic, Montreal (CA); Frank Jakob John Mueller, Scotia, NY (US); Dietmar Karl Sundermann, Fontenay-les-Briis (FR); Pingfan Wu, Niskayuna, NY (US)

Correspondence Address: SCULLY SCOTT MURPHY & PRESSER, PC, 400 GARDEN CITY PLAZA, GARDEN CITY, NY, 11530

(73) Assignee: General Electric Company, Niskayuna, NY

(21) Appl. No.: 10/338,390

(22) Filed: Jan. 8, 2003

(51) Int. Cl. G21K 1/00

(52) U.S. Cl. 378/145

(57) ABSTRACT

An LED light device comprising an LED for generating a light beam, and a reflector that concentrates the light beam to have bright illumination, uniform light field, and sharp edge contrast. The LED light device may be used in an x-ray collimator to facilitate positioning a patient and an x-ray machine relative to each other so that an x-ray beam is directed along a defined axis and onto a specified target zone on the patient. The collimator comprises at least one high energy LED array for generating a light beam and directing the light beam along the defined axis, wherein the light beam expands outward from the LED array at a beam cone angle, and an optical concentrator having a reflective surface, wherein the light beam is emitted from the LED array at a beam cone angle defined by the reflective surface of the optical concentrator.

### BACKGROUND OF THE INVENTION

This invention generally relates to an LED based light source, and to systems using such a light source. More specifically, the invention relates to an LED based light source that provides a uniform light field with well-defined, high contrasting edges, and to systems or apparatuses using such a light source.

There is a wide spread need for light sources that provide a uniform light field with well-defined edges. For example, such a light source may be used in automotive or laboratory equipment applications or any other application requiring a homogenous light field with well-defined edges. As another example, these light sources may be used in various medical systems, such as those systems that produce or use invisible electromagnetic radiation or particle beams.

Medical systems with invisible electromagnetic radiation or particle beams are widespread today, both for diagnostic and therapeutic purposes. In general, the patient must be put in a well defined position with respect to the irradiating device and receive a well delimited irradiation to assure minimum unwanted radiation to the rest of the body, both for therapy and diagnosis. This patient positioning to the radiation source is made apparent through a visible light source simulating the radiation beam geometry.

In particular for medical systems using x-rays, a device called a collimator conically delimits the x-ray beam by movable blades of x-ray absorbing material. Such a collimator may include a visible light source to visually indicate the position of the x-ray beam relative to the patient so that the x-rays will be projected onto the appropriate diagnosis or treatment area of the patient. For accurate representation of the exposure area at all distances from the collimator, the light rays must coincide with the X-rays. Since the light and the X-ray sources are different entities, they cannot physically coincide, and therefore the light source is positioned to the side of the X-ray beam at the same optical distance from the target as the X-ray source.

An optical mirror, which high transparency to X-rays, is centered on the axis of the X-ray beam and at the same distance from the light and the X-ray source. The mirror is tilted at an angle to reflect the light beam coincidentally with the X-ray beam. Precise alignment of the light source and the angle of the mirror is necessary to achieve overlap of the light and the X-ray beam. There are several additional requirements related to the light source. It needs to be inexpensive, have a high brightness, provide well-defined light field edges (good contrast) and have a long service life.

The majority of X-ray collimators and other light sources in medical systems use low voltage halogen projector lamps (e.g., 12V 150W) for the localizer light. These lamps provide sufficient light output and satisfactory edge contrast because of their small filament size. However, due to the inherent tradeoff between light output and filament lives, the halogen projector lamps have short rated lives, typically only a few hundred hours. This presents disadvantages in the collimator application, where lamp replacement involves precise optical alignment of the lamp, a task that needs to be performed by a skilled service engineer or technician. This leads to unscheduled down-time and labor costs for frequent lamp replacements.

### SUMMARY OF THE INVENTION

In a first aspect of the invention, an LED light device is provided comprising an LED for generating a light beam, and a reflective surface that concentrates the light beam to have bright illumination, uniform light field, and sharp edge contrast.

As one example, and in a second aspect of the invention, the LED light device may be used in an x-ray collimator to facilitate positioning a patient and an x-ray machine relative to each other so that an x-ray beam from the x-ray machine is directed along a defined axis and onto a specified target zone on the patient. The light source of the collimator comprises at least one high energy LED array, one optical concentrator and a mirror. The light beam is emitted from the LED array at a beam cone angled defined by the reflective surface of the optical connector.

Preferably, the LED light source has a rated life longer than the service life of the collimator (e.g., 50,000 hours), an intensity in excess of 200 lux at a distance of 100 cm from the source, and the LED light source fits in an area of 2 mm by 2 mm. Also, in the preferred embodiment, the light beam expands outward from the LED source at a beam cone angle greater than 45°, and the optical concentrator focuses the beam cone angle around 35°-40°. This embodiment preferably includes an x-ray absorbing diaphragm positioned at about 1/5 of the distance from the light source to the image receptor to give good light field edge contrast.

The present invention may be effectively employed to develop an illumination device with light output and edge contrast similar to that achieved with 150 watt halogen lamp while having significantly longer lifetime and using significantly less power. The use of a localizer lamp with a rated life longer than the service life of the system it is embedded in, for example a medical collimator, has significant appeal. It eliminates system down-time and associated labor costs due to on-site replacement of the lamp. It also simplifies mechanical design of the system (collimator) by removing provisions for easy lamp access and alignment.

### BRIEF DESCRIPTION OF THE DRAWINGS

FIG. 1 illustrates an LED light device in accordance with this invention.

FIG. 2 shows an area illuminated by the device of FIG. 1.

FIG. 3 is a graph showing the illumination intensity over an area illuminated by the light device of FIG. 1.

FIG. 4 illustrates an edge of an area illuminated by the LED light device of FIG. 1.

FIG. 5 shows an LED array that may be used in the light device of FIG. 1.

FIG. 6 shows an LED device including the array of FIG. 5.

FIG. 7 illustrates the output spectrum of the LED array of FIG. 5, as a function of intensity versus wavelength.

FIG. 8 shows an alternate LED light device also in accordance with the present invention.

FIGS. 9, 10 and 11 correspond to FIGS. 2, 3 and 4 respectively, and illustrate the illumination output from the LED light device of FIG. 8.

FIG. 12 shows another LED light source in accordance with the present invention.

FIGS. 13, 14 and 15 correspond to FIGS. 2, 3 and 4 respectively, and illustrate the illumination output from the LED light device of FIG. 12.

FIG. 16 diagrammatically illustrates an x-ray system having a collimator in accordance with the present invention.

FIG. 17 is a schematic drawing of an x-ray collimator light embodying the present invention and used in the x-ray system of FIG. 16.

FIG. 18 shows an alternate LED light assembly.

### DETAILED DESCRIPTION OF THE INVENTION

A first aspect of the invention provides a light source that provides bright illumination, uniform light field, and sharp edge contrast. In order to have sharp edge contrast for a diaphragm a given distance from the source, the size of the light source should be small.

There are various optical designs to contract the LED light beam to the desired cone angle. FIG. 1 shows a first light device 100 in accordance with this invention. Device 100 comprises an LED 102 for generating a light beam, and a diaphragm 104 that concentrates the light beam to have bright illumination, uniform light field, and sharp edge contrast. With device 100, the diaphragm 104 is in the shape of a compound parabolic contractor (CPC); and with this device, CPC 104 is directly over the die 102. The contractor has circular shaped openings at the left and right ends, and the radius of the opening at the left end (R1) is 1.5 mm, and the radius of the opening at the right end (R2) is 4.5 mm. The length (L) of the contractor is 15 mm, and the cone angle (Angle) of the light emitted from the contractor (FWHM) is 17.7°. Also, the average illumination efficiency is 35.9%, the illumination in the center of each quadrant is 182.2 lux, the minimum illumination is 136 lux, and the maximum illumination is 195 lux.

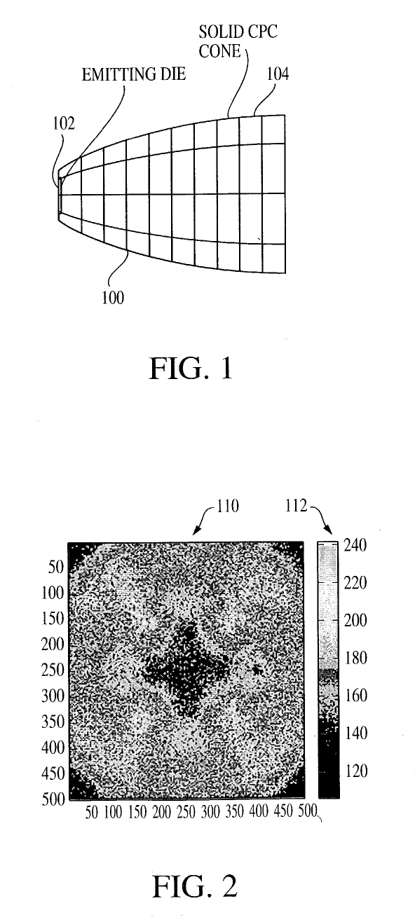

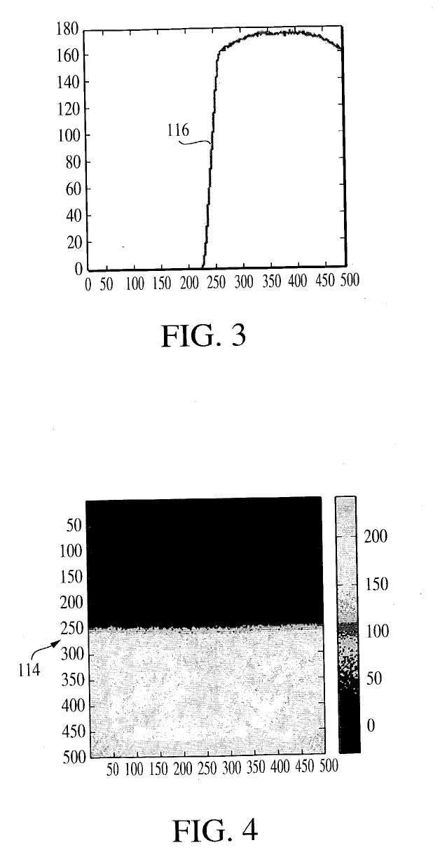

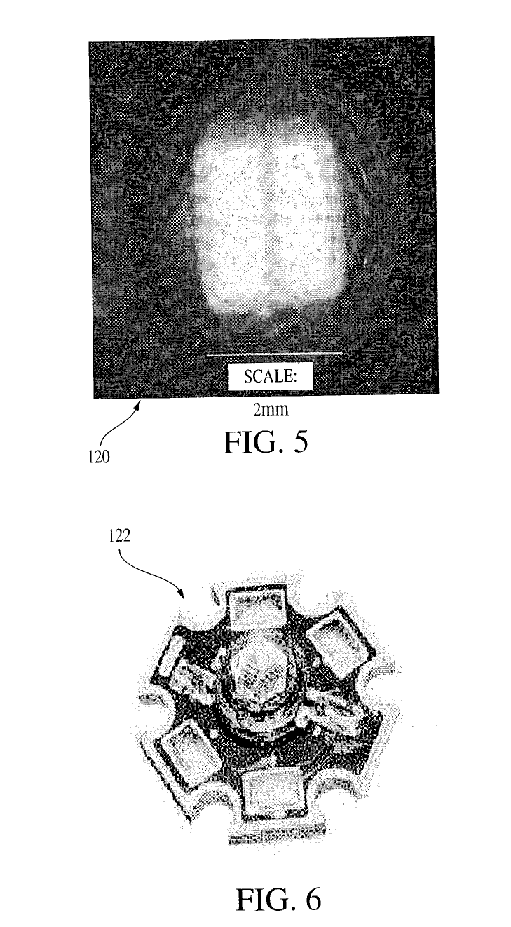

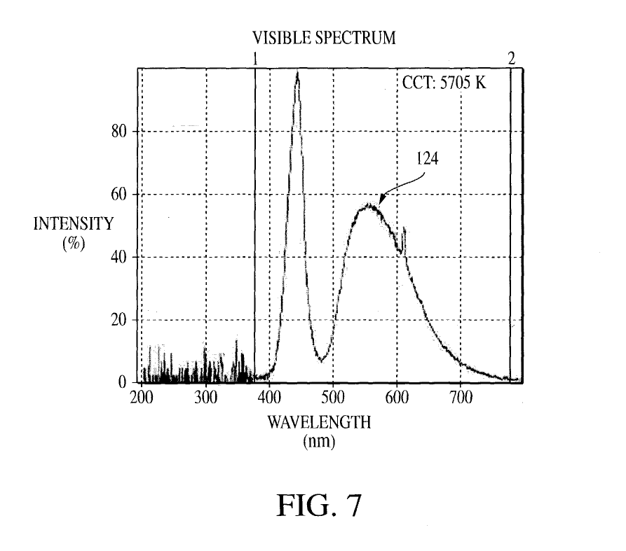

FIG. 2 shows the illumination pattern on the target from LED die 102 and focused by the integrated PCP cone 104. The light field 110, as graph 112, shows, is uniform so that the ratio between the lowest illumination and the highest illumination is about 62%. The cone has a 7 mm diameter exit pupil. The illumination efficiency from the LED die to the one-meter-away 0.5×0.5 meters target is over 35%. FIGS. 3 and 4 illustrate the sharp edge contrast achieved with device 100. With device 100, the average edge contrast (3-mm low from the centerline and 3-mm up from the centerline) is 1.5, the range from 10% to 90% along edge 114 is 30 mm, and the edge slope 116 is 4.79 lux/mm. FIG. 5 depicts an LED array 120 suitable for use in device 100, which is comprised of four 1 mm2 LEDs are on a single substrate. FIG. 6 shows LED array 120 in a module 122 with integrated lens. The luminous flux of the module with 5 watts input is 120 lm with a beam angle of 120° FWHM FIG. 7 shows the visible spectrum output 124 of LED array 120.

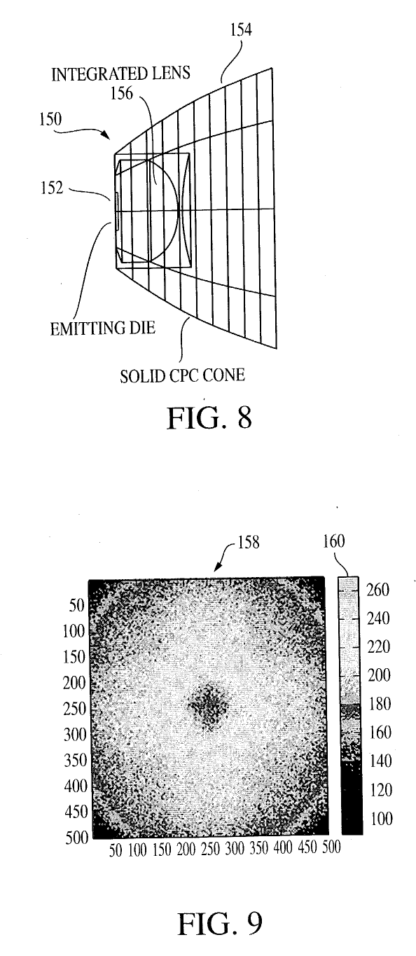

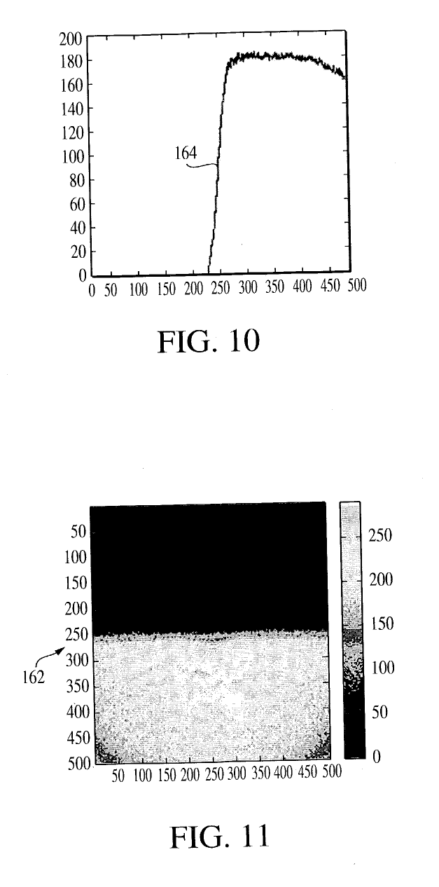

FIG. 8 shows another alternate LED light device 150 comprising LED 152 and reflector (CPC) 154, and FIGS. 9-11 illustrate the illumination intensity output of device 150. The LED die 152 is packaged inside an integrated lens 156, which is commercially available. However, the light field illuminated by the package may be too low to be used in the medical and other applications today. So a CPC cone 154 is designed on top of the LED-integrated lens package to focus the beam. The exit pupil of the outside CPC cone is about 15 mm. FIG. 9 shows an area 156 illuminated by device 150, and graph 160 shows how the illumination intensity varies across that area. With this embodiment, CPC 154 is over the die package 152, R1=3.2 mm, R2=7.5 mm, Angle=15o and L=10 mm. Also, the average illumination efficiency is 37.2%, the illumination in the center of each quadrant is 187 lux, the minimum illumination is 108 lux, and the maximum illumination is 203 lux. With embodiment 150, the average edge contrast (3-mm low from the centerline and 3-mm up from the centerline) is 1.458, the range from 10% to 90% along edge 162 is 38 mm, and the edge slope 164 is 4.17 lux/mm.

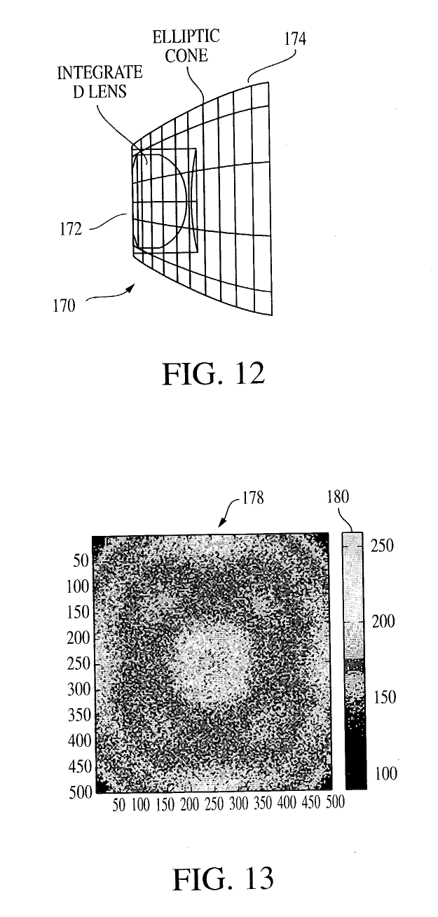

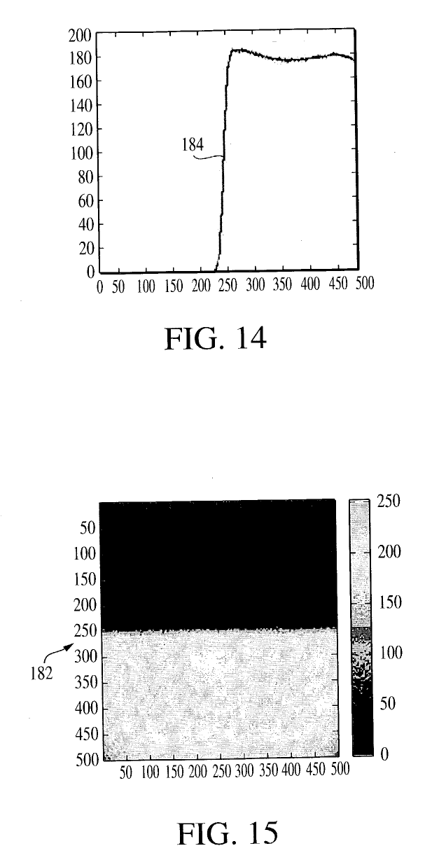

FIG. 12 shows a third design 170, in accordance with the present invention, which is similar as the second design 150, but the TIR cone 174 is in elliptical shape. The exit pupil of the outside elliptical cone is also 15 mm. Compared to the two previous designs 104 and 154, the cone 174 has better edge contrast. FIGS. 13-15 illustrate the illumination intensity output of device 170. Design 170 is similar to design 150 shown in FIG. 8, but the TIR core 174 is elliptical in shape. FIG. 13 shows an area 172 illuminated by device 170, and graph 174 shows how the illumination intensity varies across that area. Device 170 comprises LED 172 and TIR cone 174. In this embodiment, diaphragm 174 is an elliptic cone over the die package 172, R1=3.2 mm, R2=7 mm, and L=10 mm. Also, the average illumination efficiency is 37.2%, the illumination in the center of each quadrant is 169.14 lux, the minimum illumination is 125.13 lux, and the maximum illumination is 194.68 lux. With embodiment 170, the average edge contrast (3-mm low from the centerline and 3-mm up from the centerline) is 1.923, the range from 10% to 90% along edge 182 is 19 mm, and the edge slope 184 is 7.713 lux/mm.

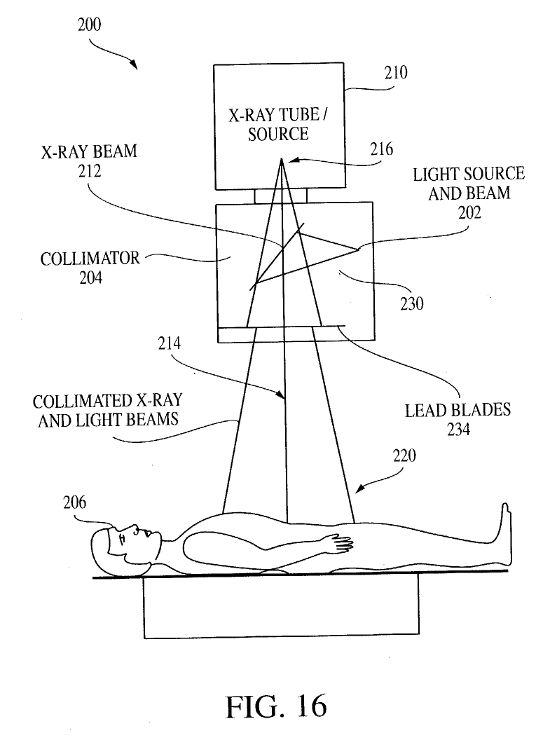

As one example of how the invention can be applied in medical x-ray systems, FIG. 16 generally illustrates an x-ray machine 200 having an LED based light source 202 within a collimator 204. A patient 206 to be treated or examined is positioned adjacent the machine 200; and an x-ray source 210 then projects a beam 212 of x-rays along axis 214 from a focal spot 216 to a treatment zone 220 of the patient. The radiation beam may be electron radiation (example: radiotherapy) or photon radiation. The x-ray machine 200 may be supported by a gantry (not shown) that allows the machine to be swiveled or rotated about a horizontal axis, and this, in turn, allows the x-rays to be directed to different areas of the patient.

A beam 230 of visible light from source 202 is projected along axis 214 that allows an operator to non-intrusively adjust that axis and the dimension of the beam that is projected along the axis. When the system 200 is switched to the operation mode, the visible light is replaced with the radiation beam 212. Lead blades 234 delimit or collimate the light beam 230 and the x-ray beam 212 to the treatment zone 24.

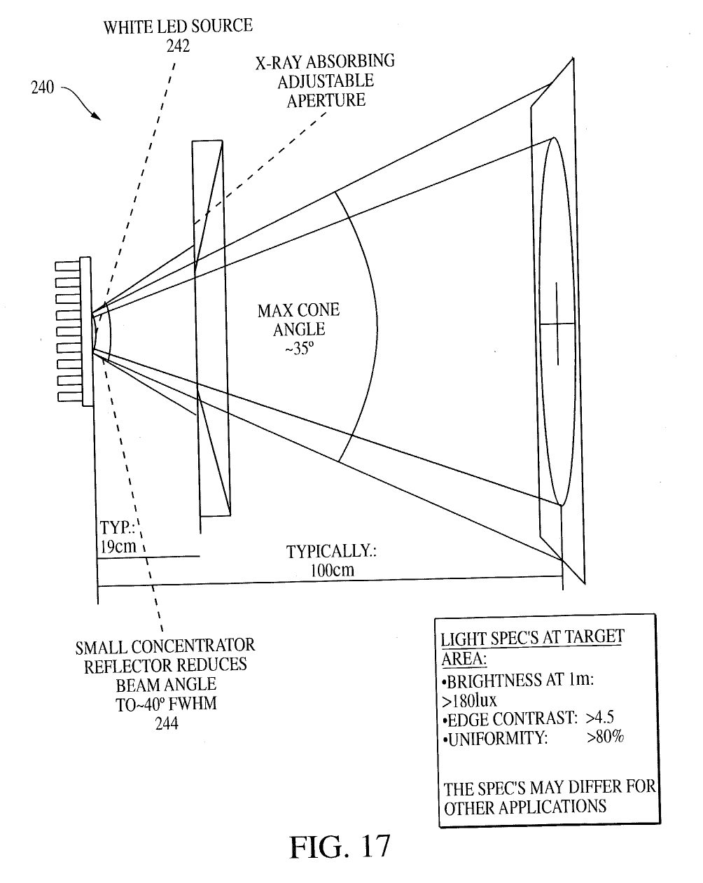

FIG. 17 shows the light assembly 240 that is part of a collimator 204 that is preferably used in x-ray system 200 to provide the visible light used to set-up the x-ray machine 200. Generally, the collimator 204 includes at least one high power LED array 242 and one optical contractor 244 to focus the beam to the desired cone angle. Also, in the preferred embodiment, the size of the LED array 242 needs to be small enough to fit in a circle or square with an area less than 2×2 mm2. For more general applications, the diaphragm does not need to be x-ray absorbent; only light absorbing would be enough for many non-x-ray applications.

The use of a localized lamp with a rated life longer than the service life of the collimator has a substantial advantage. It eliminates system down-time and associated labor costs due to on-site replacement of the lamp. It also simplifies the mechanical design of the collimator by eliminating the need to provide for easy lamp access and alignment.

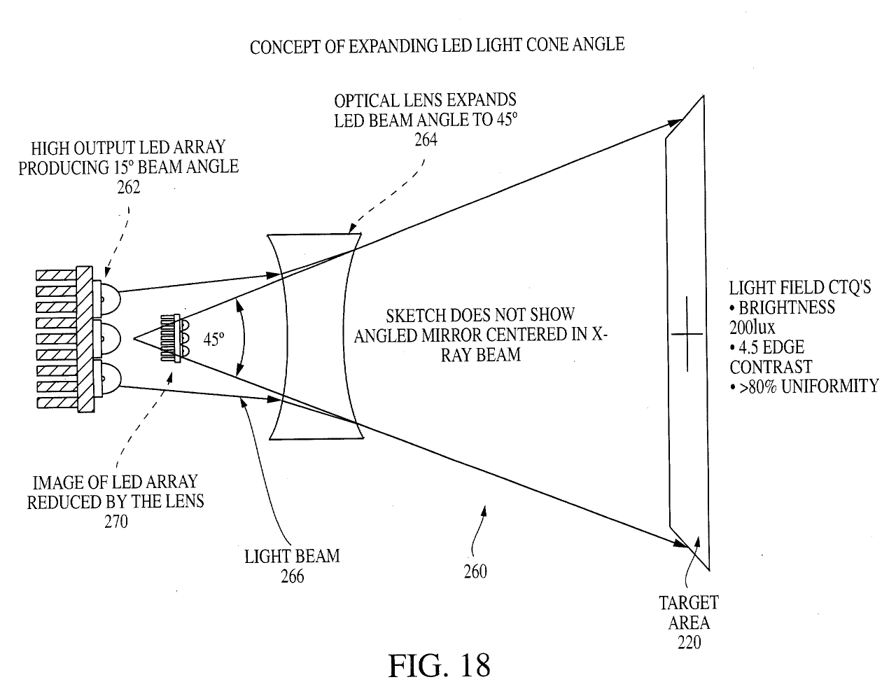

FIG. 18 shows an alternate LED light assembly 260 that may be part of collimator 204. Generally, the LED light assembly 260 includes at least one high output LED array 262 with narrow beam angle and one or more lens 264. The LED array provides a light beam 266, and preferably, this light beam has a brightness of at least 200 lux at a distance of 100 cm from source. The size of the LED array 262 should preferably be small enough to fit in a circle or square with an area less than 300 mm². Each LED 262 needs to have a narrow beam angle (less than 15° cone.) Using optical lens 264 or lenses, the beam 266 is expanded to a desired (35-45°) cone angle for illumination of the target area 220 of patient 206. The optics of collimator 260 also helps to reduce the size of the virtual LED source 270, resulting in a much better edge contrast at the patient target area.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. An LED light device comprising:
an LED for generating a light beam; and
a reflector that concentrates the light beam to have bright illumination, uniform light field, and sharp edge contrast.

2. An LED light device according to claim 1, wherein the LED is packaged inside a compound parabolic concentrator (CPC) shaped cone.

3. An LED light device according to claim 1, wherein an outside compound parabolic concentrator (CPC) shaped cone focuses the light from the LED to a desired cone angle.

4. An LED light device according to claim 1, wherein an outside elliptical shaped cone focuses the light from the LED to a desired angle.

5. An LED based light source within an x-ray collimator to facilitate positioning a patient and an x-ray machine relative to each other so that an x-ray beam from the x-ray machine is directed along a defined axis and onto a specified target zone on the patient, the collimator comprising:
at least one high energy LED array for generating a light beam and directing the light beam along the defined axis, wherein the light beam expands outward from the LED array at a beam cone angle: and
an optical concentrator having a reflective surface, wherein the light beam is emitted from the LED array at a beam cone angle defined by the reflective surface of the optical concentrator.

6. A collimator according to claim 5, wherein the light beam is emitted outward from the LED array.

7. A collimator according to claim 5, wherein the light beam expands outward from the LED array at a beam cone angle of substantially 15°.

8. A collimator according to claim 5, further comprising a lens for concentrating the beam cone angle to approximately 35°.

9. A collimator according to claim 5, wherein the lens concentrates the beam cone angle to substantially 35°.

10. A collimator according to claim 5, wherein the LED array fits in an area less than 30 mm².

11. A collimator according to claim 10, wherein the LED array has a size less than 5 mm×5 mm.

12. A collimator according to claim 5, wherein the LED array produces a light beam having an intensity of at least 200 lux.

13. A collimator according to claim 5, further comprising at least one concentrator including a single lens.

14. A collimator according to claim 5, further comprising at least one concentrator including a reflector.

15. A method of positioning an x-ray machine and a patient relative to each other, the method comprising the steps of:
providing the x-ray machine with an LED array to generate a light beam and to direct the light beam along a given axis, wherein the light beam expands outward from the LED array at a beam cone angle;
positioning a lens in the path of the light beam to expand the beam cone angle outward;
positioning the patient and the x-ray machine relative to each other so that the light beam is incident on a defined target area of the patient; and
using the x-ray machine to generate an x-ray beam and to direct the x-ray beam onto said given axis and onto the defined target area of the patient.

16. A method according to claim 15, wherein:
the light beam expands outward from the LED array at a beam cone angle between 10°-15°; and
the lens expands the beam cone angle to approximately 35°.

17. A method according to claim 16, wherein:
the light beam expands outward from the LED array at a beam cone angle of substantially 15°; and
the lens expands the beam cone angle to substantially 35°.

18. A method according to claim 17, wherein:
the LED array fits in an area less than 300 mm²; and
the LED array produces a light beam having an intensity of at least 200 lux.

19. An x-ray machine, comprising:
a beam generator for generating a beam of x-rays and directing the beam along a given axis; and
a collimator to facilitate positioning a patient and the x-ray machine relative to each other so that the x-ray beam from the x-ray machine is directed onto a specified target zone on the patient, the collimator including
i) at least one high energy LED array for generating a light beam and directing the light beam along the given axis, wherein the light beam expands outward from the LED array at a beam cone angle, and
ii) at least one lens positioned in the path of said light beam to expand the beam cone angle.

20. An x-ray machine according to claim 14, wherein:
the light beam expands outward from the LED array at a beam cone angle between 10°-15°; and
the lens expands the beam cone angle to substantially 35°.

21. An x-ray machine according to claim 20, wherein:
the light beam expands outward from the LED array at a beam cone angle of substantially 15°.

22. An x-ray machine according to claim 21, wherein:
the LED array fits in an area less than 30 mm²; and
the LED array produces a light beam having an intensity of at least 200 lux.

23. An x-ray machine according to claim 22, wherein the LED array has a size approximately 2 mm×2 mm.
